(19) United States
(12) Patent Application Publication
(10) Pub. No.: US 2009/0101676 A1
(43) Pub. Date: Apr. 23, 2009

(54) Pump Dispenser With Indented Actuator Skirt

(76) Inventors: Tami O'Connell, Pleasanton, CA (US); Agnete Enga, Brooklyn, NY (US); John Kiechel, San Francisco, CA (US); Nasahn Sheppard, Mill Valley, CA (US)

Correspondence Address: THE CLOROX COMPANY, P.O. BOX 24305, OAKLAND, CA, 94623-1305, US

(21) Appl. No.: 11/876,395

(22) Filed: Oct. 22, 2007

(51) Int. Cl. B67D 5/06; G01F 11/00; B65D 88/54

(52) U.S. Cl. 222/205; 222/330; 222/321.9

(57) ABSTRACT

A vertical pump-up dispenser has a concave actuator skirt which allows the consumer to identify the actuator platform and minimize interference with the container.

### BACKGROUND OF THE INVENTION

1. Field of the Invention

This invention relates to pump-up dispensers with indented actuator skirts for use in delivering liquids to surfaces such as soft surfaces like paper towels, hard surfaces such as dishes, and body surfaces such as hands.

2. Description of the Related Art

Current dispensers are not adequate for one hand application of cleaning and disinfecting compositions to cleaning substrates such as paper towels. Dispensers such as trigger sprayers or pump-down dispensers generally require one hand to hold and activate the dispenser and one hand to hold the cleaning substrates. Existing pump-up dispensers that can be ergonomically operated with the same hand that holds the cleaning substrate have small actuators that require the hand and substrate to be contracted into a ball in order to activate the dispenser. An existing pump-up dispenser also has an exterior skirt that does not convey a separation of the actuator top from the container base. As the actuator top and exterior actuator skirt get larger to meet consumer needs, there is potentially even more confusion between the actuator and the container base. Prior art dispensers with interior skirts have only slightly sloping actuator skirts that do not allow the consumer to easily identify the actuator platform and, in addition, the slightly sloping skirt can create greater interference with the container bottom during dispenser actuation.

To overcome these problems of dispensers of the prior art, the dispenser of the present invention is designed to allow the consumer to conveniently identify the actuator top by the slope in the actuator skirt and this additionally can allow the actuator skirt to have minimal interference with the container base.

### SUMMARY OF THE INVENTION

In accordance with the above objects and those that will be mentioned and will become apparent below, one aspect of the present invention comprises a package for dispensing a liquid having a curved actuator skirt comprising a container having a container bottom, a container sleeve coupled to the container bottom and depending upwardly from the peripheral edge of the container bottom; an actuator having an actuator top and an actuator skirt coupled to the actuator top and depending downwardly from the actuator top; a pump assembly having a hollow stem and the pump assembly disposed within the container and in fluid communication with the actuator; wherein the actuator has at least one discharge orifice in fluid communication with the stem of the pump assembly to permit liquid to flow on to a top surface of the actuator top upon reciprocation of the actuator top; wherein a sleeve interior surface of the container sleeve is slideably engagable with a skirt exterior surface of the actuator skirt; and wherein the actuator skirt cross-sectional area has a negative second derivative with respect to and along at least some of its length from top to bottom.

In accordance with the above objects and those that will be mentioned and will become apparent below, another aspect of the present invention comprises a package for dispensing a liquid having a curved actuator skirt comprising a container having a container bottom, a container sleeve coupled to the container bottom and depending upwardly from the peripheral edge of the container bottom; an actuator having an actuator top and an actuator skirt coupled to the actuator top and depending downwardly from the actuator top; a pump assembly having a hollow stem and the pump assembly disposed within the container and in fluid communication with the actuator; wherein the actuator has at least one discharge orifice in fluid communication with the stem of the pump assembly to permit liquid to flow on to a top surface of the actuator top upon reciprocation of the actuator top; wherein a sleeve interior surface of the container sleeve is slideably engagable with a skirt exterior surface of the actuator skirt; and wherein the actuator skirt forms a concave curve.

In accordance with the above objects and those that will be mentioned and will become apparent below, another aspect of the present invention comprises a package for dispensing a liquid having a curved actuator skirt comprising a container having a container bottom, a container sleeve coupled to the container bottom and depending upwardly from the peripheral edge of the container bottom; an actuator having an actuator top and an actuator skirt coupled to the actuator top and depending downwardly from the actuator top; a pump assembly having a hollow stem and the pump assembly disposed within the container and in fluid communication with the actuator; wherein the actuator has at least one discharge orifice in fluid communication with the stem of the pump assembly to permit liquid to flow on to a top surface of the actuator top upon reciprocation of the actuator top; and wherein the actuator skirt forms a concave curve.

### BRIEF DESCRIPTION OF THE DRAWINGS

In the accompanying drawings that form part of the specification, and in which like numerals are employed to designate like parts throughout the same,

FIG. 1 is a front view of a prior art dispenser;

FIG. 2 is a front cross-sectional view of another prior art package;

FIG. 3 is a perspective view of a prior art package;

FIG. 4 is a front cross-sectional view of an embodiment of a pump dispensing package of the present invention, and the package is shown assembled in a condition prior to use;

FIG. 5 is a front view of an embodiment of a pump dispensing package of the present invention, and the package is shown assembled in a condition prior to use;

FIG. 6 is a side view of an embodiment of a pump dispensing package of the present invention, and the package is shown assembled in a condition prior to use;

FIG. 7 is a perspective view of an embodiment of a pump dispensing package of the present invention, and the package is shown assembled in a condition prior to use; and

FIG. 8 is a graph of the cross-sectional area of the skirt versus the normalized vertical position from bottom to top.

### DETAILED DESCRIPTION OF THE INVENTION

While this invention is susceptible of embodiment in many different forms, this specification and the accompanying drawings disclose only some specific forms as examples of the invention. The invention is not intended to be limited to the embodiments so described. It is also to be understood that the terminology used herein is for the purpose of describing particular embodiments of the invention only, and is not intended to limit the scope of the invention in any manner. The scope of the invention is pointed out in the appended claims.

For ease of description, the components of this invention and the container employed with the components of this invention are described in the normal (upright) operating position, and terms such as upper, lower, horizontal, etc., are used with reference to this position. It will be understood, however, that the components embodying this invention may be manufactured, stored, transported, used, and sold in an orientation other than the position described.

Figures illustrating the components of this invention and the container show some conventional mechanical elements that are known and that will be recognized by one skilled in the art. The detailed descriptions of such elements are not necessary to an understanding of the invention, and accordingly, are herein presented only to the degree necessary to facilitate an understanding of the novel features of the present invention.

All publications, patents and patent applications cited herein, whether supra or infra, are hereby incorporated by reference in their entirety to the same extent as if each individual publication, patent or patent application was specifically and individually indicated to be incorporated by reference.

As used herein and in the claims, the term “comprising” is inclusive or open-ended and does not exclude additional unrecited elements, compositional components, or method steps. Accordingly, the term “comprising” encompasses the more restrictive terms “consisting essentially of” and “consisting of”.

It must be noted that, as used in this specification and the appended claims, the singular forms “a,” “an” and “the” include plural referents unless the content clearly dictates otherwise. Thus, for example, reference to a “surfactant” includes two or more such surfactants.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

It should be understood that every limit given throughout this specification will include every lower, or higher limit, as the case may be, as if such lower or higher limit was expressly written herein. Every range given throughout this specification will include every narrower range that falls within such broader range, as if such narrower ranges were all expressly written herein.

The term “plastic” is defined herein as any polymeric material that is capable of being shaped or molded, with or without the application of heat. Usually plastics are a homo-polymer or co-polymer that of high molecular weight. Plastics fitting this definition include, but are not limited to, polyolefins, polyesters, nylon, vinyl, acrylic, polycarbonates, polystyrene, and polyurethane.

### Package

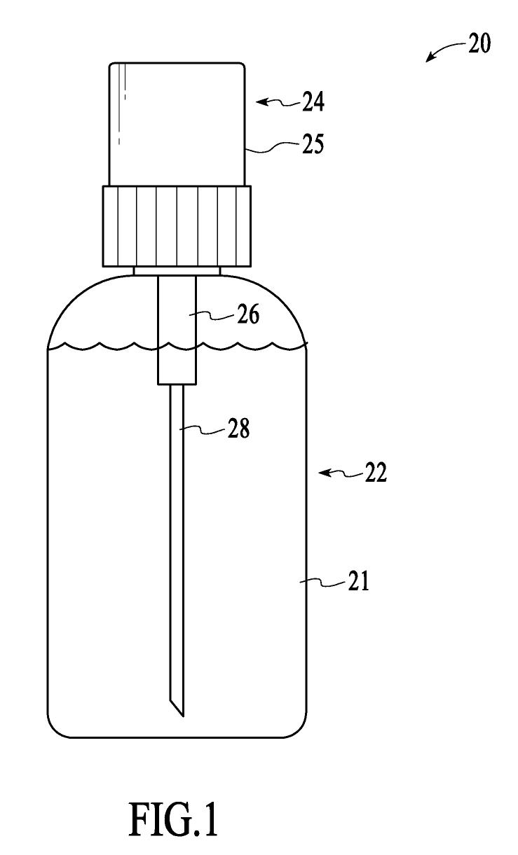

FIG. 1 illustrates a typical pump-up dispenser 20 employing an actuator 24 having a vertical straight exterior skirt 25, a pump assembly 26, and a dip tube 28 installed on a container 22. In this embodiment, the container 22 is transparent or translucent and contains a cleaning composition 21.

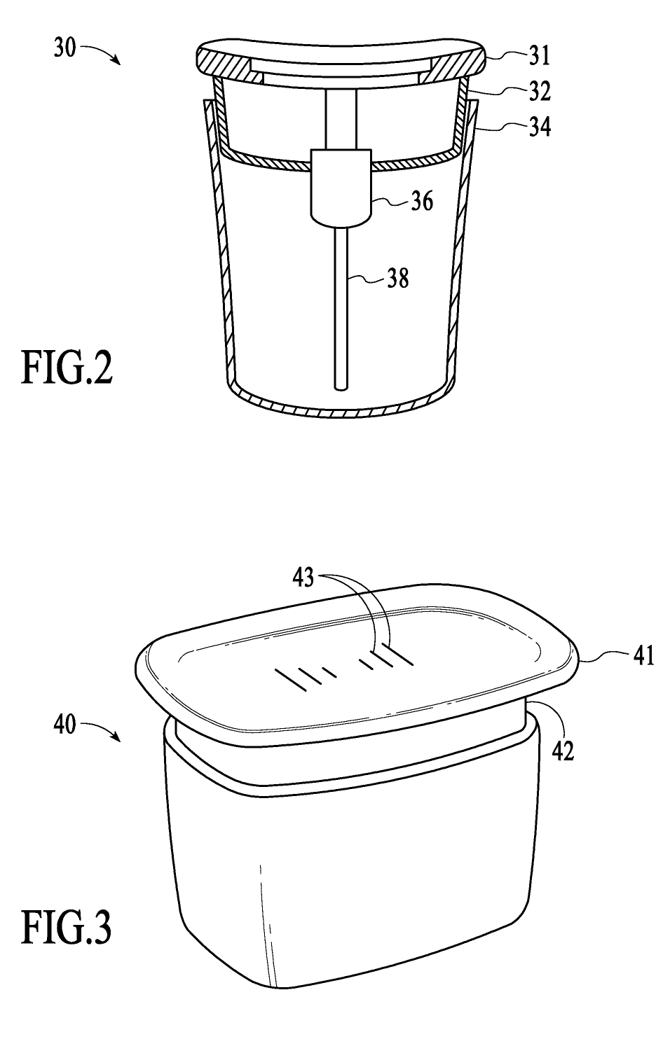

FIG. 2 illustrates a front cross-sectional view of a pump-up dispenser 30 (as described in U.S. patent application Ser. No. 11/551836) employing an actuator 31 having a slanted interior skirt 32 with substantial interference with the container base 34. The dispenser 30 also includes a pump assembly 36, and a dip tube 38.

FIG. 3 illustrates a perspective view of a pump-up dispenser 40 (as described in U.S. patent application Ser. No. 11/551836 and specifically incorporated by reference herein) having a slanted interior skirt 42 with a limited identification for the consumer of the actuator top 41. This perspective view additionally shows slotted orifices 43 to deliver a cleaning composition or other liquid.

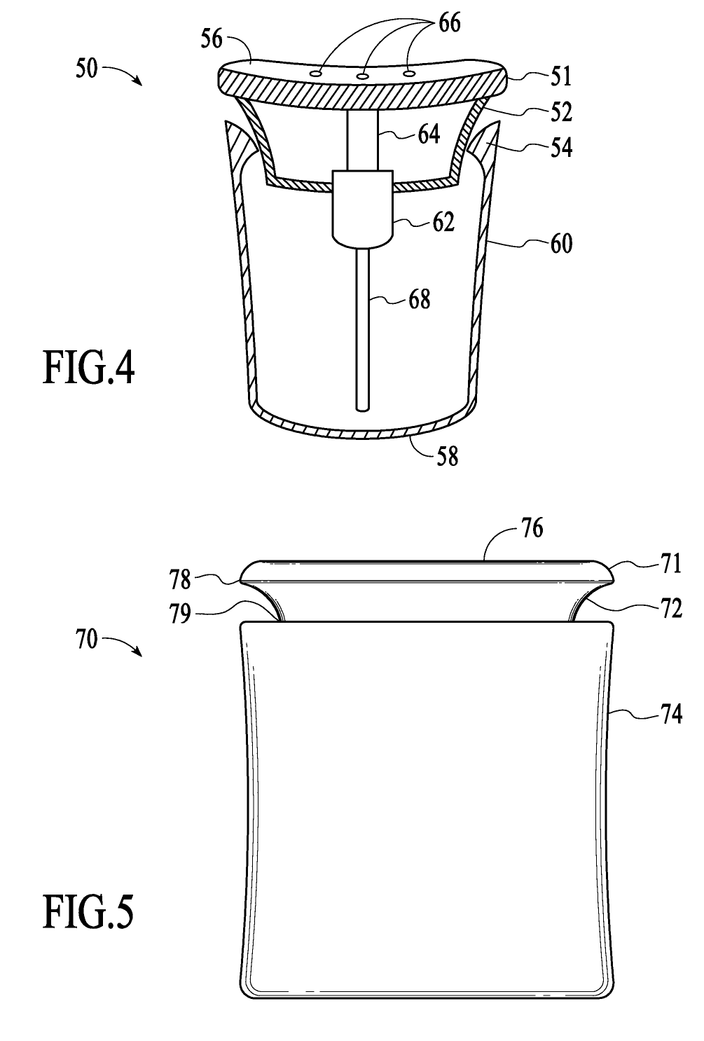

FIG. 4 illustrates a front cross-sectional view of one embodiment of the invention showing dispenser 50 having an actuator 56 with an actuator top 51 and a curved, concave interior skirt 52 coupled to the actuator top 51 and depending downwardly from the actuator top 51 and with less interference with the container base 54 compared to the slanted actuator skirt 32 in FIG. 2. The container base 54 has a container bottom 58, a container sleeve 60 coupled to the container bottom 58 and depending upwardly from the peripheral edge of the container bottom 58. The dispenser 50 has a pump assembly 62 having a hollow stem 64 and the pump assembly 62 disposed within the container base 54 and in fluid communication with the actuator 56; wherein the actuator 56 has at least one discharge orifice 66 in fluid communication with the stem 64 of the pump assembly 62 to permit liquid to flow on to a top surface of the actuator top 51 upon reciprocation of the actuator top 51; wherein a sleeve interior surface of the container sleeve 60 is slideably engagable with a skirt exterior surface of the actuator skirt 52; and wherein the actuator skirt 52 forms a concave curve

It will be appreciated that the particular design of the pump assembly 62 may be of any suitable design for pumping a product from the container 54 (with or without a dip tube 68) and out through the stem 64. The detailed design and construction of the pump assembly 62 per se forms no part of the present invention except to the extent that the pump assembly 62 is adapted to be suitably mounted and held on the container by a closure with a suitable mounting system.

FIG. 5 illustrates a front view of an embodiment of the invention showing dispenser 70 having an actuator 76 with an actuator top 71 having a curved, concave interior skirt 72 coupled to the actuator top 71 and depending downwardly from the actuator top 71 above the container base 74. The actuator skirt 72 has an actuator skirt top 78 and an actuator skirt bottom 79. The container base 74 has a concave container sleeve depending upwardly from the container bottom.

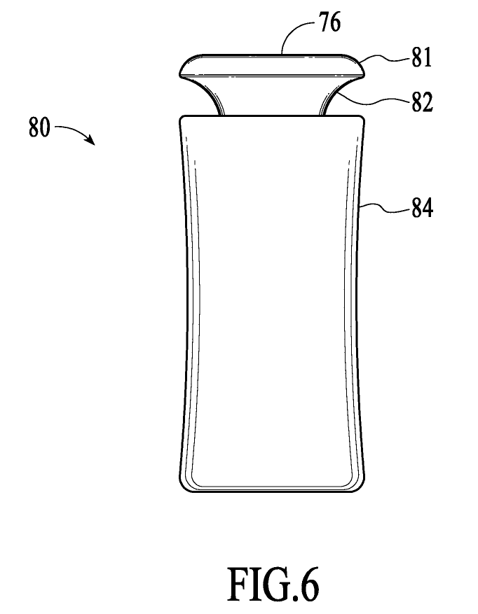

FIG. 6 illustrates a side view of an embodiment of the invention showing dispenser 80 having an actuator 86 with an actuator top 81 having a curved, concave interior skirt 82 coupled to the actuator top 81 and depending downwardly from the actuator top 81 above the container base 84.

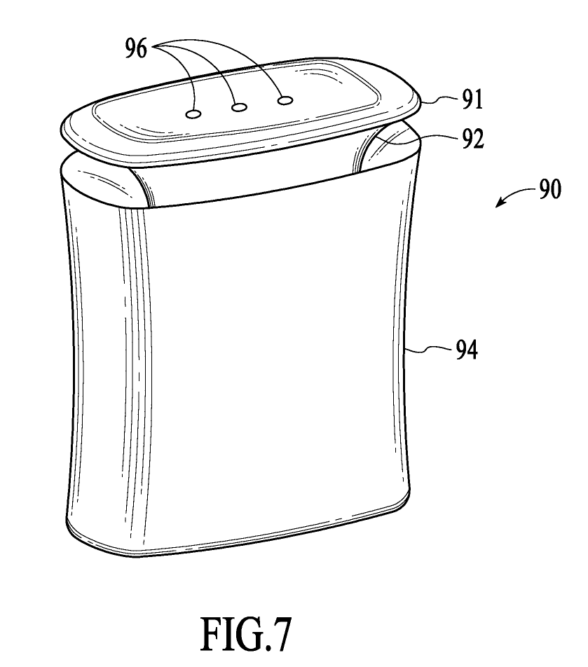

FIG. 7 illustrates a perspective view of an embodiment of the invention showing dispenser 90 having an actuator 96 with an actuator top 91 having a curved, concave interior skirt 92 coupled to the actuator top 91 and depending downwardly from the actuator top 91 above the container base 94.

While the present invention may be practiced with spray or liquid pumps of many different designs, the internal design configuration of one suitable pump is generally disclosed in U.S. Pat. No. 4,986,453, the disclosure of which is hereby incorporated herein by reference thereto. It should be understood, however, that the present invention is suitable for use with a variety of hand-operable pumps.

The container, and other components of the dispenser package, can be constructed of any of the conventional material employed in fabricating containers, including, but not limited to: polyethylene; polypropylene; polyacetal; polycarbonate; polyethyleneterephthalate; polyvinyl chloride; polystyrene; blends of polyethylene, vinyl acetate, and rubber elastomer. Other materials can include stainless steel and glass. A suitable container is made of clear material, e.g., polyethylene terephthalate.

### Indented Actuator Skirt

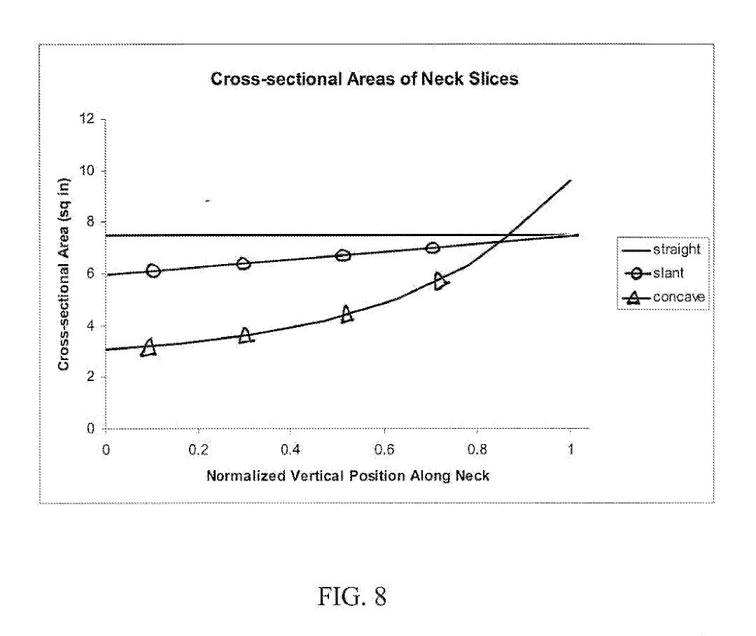

FIG. 8 is a graph of the cross-sectional area of the actuator skirt (or neck) slices versus the normalized vertical position from bottom to top of the actuator skirt for various skirt options. For a straight, vertical skirt, the cross-sectional area of the skirt (or neck) slices does not change from bottom to top of the neck, an example of which is FIG. 1. For a slanted skirt, the cross-sectional area of the skirt increases from bottom to top of the neck and the first derivative of the cross-sectional area of the skirt (or neck) slices versus the normalized vertical position is positive. An example of this situation is FIG. 2. For a concave curved skirt, the cross-sectional area of the skirt increases from bottom to top of the neck and both the first and second derivative of the cross-sectional area of the skirt (or neck) slices versus the normalized vertical position are positive. An example of this situation is FIG. 4.

### Compositions

The dispenser can be used to transfer a wide variety of compositions to a substrate. These compositions include hard surface cleaners and sanitizers, personal care cleaners and other products, hand sanitizers, dish soap, laundry pre-treater, food products such as marinades, car products such as cleaners or protectants, and baby care products such as baby lotion.

### Methods of Use

Consumers enjoy the ease of use of the invention for reasons such as it utilizes cleaners differently, provides control such as no overspray, can be used one-handed, is compatible with wide variety of substrates, utilizes direct application so that no particles are aerosolized into the air, allows easy multi-tasking with other household activities, and is not limited by number of doses or wipes. Because of this flexibility, the consumer has more control to make the exact use conditions suitable to the task.

The dispensing package can be used as a one-handed method of cleaning a surface, where the consumer grabs a substrate in her hand, pushes the substrate down on the actuator top of the dispensing package with her hand, allows the actuator top to come up and discharge a cleaning composition from the dispensing package to the substrate, and wipes the surface with the substrate. The substrate can be a paper towel, facial tissue, sheet of toilet tissue, a napkin, a sponge, a towel, or any other suitable woven or nonwoven substrate. Because the cleaning task takes only one hand, the other hand is free to perform another activity, such as holding a telephone, eating a snack and the task can be done quickly and easily without carrying the dispensing package to the area of the task.

Because the consumer is unfamiliar with the one-handed method of cleaning a surface, certain use indications can be supplied as directions for use of the dispensing package, however, proper utilitarian design of the dispensing package makes its use intuitive. One example of the components of the device allowing for intuitive use is having a concave, rather than a slanted or vertical actuator skirt.

While this detailed description includes specific examples according to the invention, those skilled in the art will appreciate that there are many variations of these examples that would nevertheless fall within the general scope of the invention and for which protection is sought in the appended claims.

What is claimed is:

1. A package for dispensing a liquid having a concave actuator skirt comprising:
a. a container having a container bottom, a container sleeve coupled to the container bottom and depending upwardly from the peripheral edge of the container bottom;
b. an actuator having an actuator top and an actuator skirt coupled to the actuator top and depending downwardly from the actuator top;
c. a pump assembly having a hollow stem and the pump assembly disposed within the container and in fluid communication with the actuator;
d. wherein the actuator has at least one discharge orifice in fluid communication with the stem of the pump assembly to permit liquid to flow on to a top surface of the actuator top upon reciprocation of the actuator top;
e. wherein a sleeve interior surface of the container sleeve is slideably engagable with a skirt exterior surface of the actuator skirt; and
f. wherein the actuator skirt forms a concave curve.

2. The package of claim 1, wherein the actuator has more than one discharge orifice.

3. The package of claim 1, wherein the actuator has at least one slotted discharge orifice.

4. The package of claim 1, wherein container is transparent or translucent.

5. The package of claim 1, wherein the package additionally comprises a dip tube.

6. The package of claim 1, wherein the container sleeve is concave.

7. A package for dispensing a liquid having a concave actuator skirt comprising:
a. a container having a container bottom, a container sleeve coupled to the container bottom and depending upwardly from the peripheral edge of the container bottom;
b. an actuator having an actuator top and an actuator skirt coupled to the actuator top and depending downwardly from the actuator top;
c. a pump assembly having a hollow stem and the pump assembly disposed within the container and in fluid communication with the actuator;
d. wherein the actuator has at least one discharge orifice in fluid communication with the stem of the pump assembly to permit liquid to flow on to a top surface of the actuator top upon reciprocation of the actuator top; and
e. wherein the actuator skirt forms a concave curve.

8. The package of claim 7, wherein the actuator has more than one discharge orifice.

9. The package of claim 7, wherein the actuator has at least one slotted discharge orifice.

10. The package of claim 7, wherein container is transparent or translucent.

11. The package of claim 7, wherein the package additionally comprises a dip tube.

12. The package of claim 7, wherein the container sleeve is concave.

13. A package for dispensing a liquid having a curved actuator skirt comprising:
a. a container having a container bottom, a container sleeve coupled to the container bottom and depending upwardly from the peripheral edge of the container bottom;
b. an actuator having an actuator top and an actuator skirt coupled to the actuator top and depending downwardly from the actuator top;
c. a pump assembly having a hollow stem and the pump assembly disposed within the container and in fluid communication with the actuator;
d. wherein the actuator has at least one discharge orifice in fluid communication with the stem of the pump assembly to permit liquid to flow on to a top surface of the actuator top upon reciprocation of the actuator top;
e. wherein a sleeve interior surface of the container sleeve is slideably engagable with a skirt exterior surface of the actuator skirt; and
f. wherein the actuator skirt cross-sectional area has a negative second derivative with respect to and along at least some of its length from top to bottom.

14. The package of claim 13, wherein the actuator has more than one discharge orifice.

15. The package of claim 13, wherein the actuator has at least one slotted discharge orifice.

16. The package of claim 13, wherein container is transparent or translucent.

17. The package of claim 13, wherein the package additionally comprises a dip tube.

18. The package of claim 13, wherein the container sleeve is concave.
